(19) United States
(12) Patent Application Publication
(10) Pub. No.: US 2017/0176594 A1
(43) Pub. Date: Jun. 22, 2017

(54) OBSTACLE DETECTION DEVICE

(71) Applicant: Panasonic Intellectual Property Management Co., Ltd., Osaka (JP)

(72) Inventors: TORU ICHIKAWA, Kanagawa (JP); SHINYA OGAWA, Kanagawa (JP); TOHRU FUKUDA, Hiroshima (JP); YUKI OSATO, Kanagawa (JP)

(21) Appl. No.: 15/452,968

(22) Filed: Mar. 8, 2017

Related U.S. Application Data
(63) Continuation of application No. PCT/JP2015/003813, filed on Jul. 29, 2015.

(30) Foreign Application Priority Data
Sep. 19, 2014 (JP) 2014-191238

(51) Int. Cl. G01S 15/93; G08G 1/16

(52) U.S. Cl. CPC G01S 15/931; G08G 1/16

(57) ABSTRACT

This obstacle detection device is mounted on a vehicle. This obstacle detection device includes a plurality of ultrasonic sensors, and a detector. The plurality of ultrasonic sensors transmits a plurality of ultrasonic waves of different frequencies to detection areas which overlap with each other at transmission timings which overlap with each other, and each of the ultrasonic sensors receives a returning ultrasonic wave. The detector identifies which one ultrasonic wave of a plurality of ultrasonic waves is reflected as the received returning ultrasonic wave, and detects a position of an obstacle existing around the vehicle.

### TECHNICAL FIELD

The present disclosure relates to an obstacle detection device which detects obstacles existing around a vehicle.

### BACKGROUND ART

Conventionally, an obstacle detection device which detects obstacles existing around a vehicle by using a plurality of ultrasonic sensors (also referred to as sonars) mounted on the vehicle is known (see, for example, PTL 1).

The ultrasonic sensors can detect a distance to each obstacle based on a time from transmission to reception and a sonic speed by transmitting an ultrasonic wave and then receiving the returning ultrasonic wave reflected by each obstacle. By activating a plurality of ultrasonic sensors in one detection area and causing each ultrasonic sensor to measure a distance to each obstacle, it is possible to detect a position of each obstacle by trilateration.

Conventionally, when a plurality of ultrasonic sensors is activated in one detection area, a plurality of ultrasonic sensors is usually operated by shifting times such that a plurality of ultrasonic sensors does not interfere with each other.

PTL 1 discloses a technique of preventing interference between a back sonar and a clearance sonar whose detection areas do not overlap with each other among a plurality of ultrasonic sensors. PTL 1 discloses alternately transmitting ultrasonic waves to two back sonars whose detection areas overlap by switching wave transmission channels.

### CITATION LIST

### Patent Literature

PTL 1: Unexamined Japanese Patent Publication No. H03-57738

### SUMMARY

An obstacle detection device according to the present disclosure is mounted on a vehicle. This obstacle detection device includes a plurality of ultrasonic sensors, and a detector. The plurality of ultrasonic sensors transmits a plurality of ultrasonic waves of different frequencies to detection areas at least parts of which overlap with each other at transmission timings at least parts of which overlap with each other, and each of the ultrasonic sensors receives a returning ultrasonic wave. The detector identifies which one ultrasonic wave of the plurality of ultrasonic waves is reflected as the received returning ultrasonic wave, and detects a position of an obstacle existing around the vehicle.

According to the present disclosure, it is possible to precisely detect a position of an obstacle by using a plurality of ultrasonic sensors whose detection areas overlap.

### BRIEF DESCRIPTION OF DRAWINGS

FIG. 1 is a block diagram illustrating a configuration of an obstacle detection device according to a first exemplary embodiment of the present disclosure.

FIG. 2 is a view illustrating an ultrasonic wave transmitted from the obstacle detection device according to the first exemplary embodiment of the present disclosure.

FIG. 3 is a view illustrating detection areas of ultrasonic waves transmitted from the obstacle detection device according to the first exemplary embodiment of the present disclosure.

FIG. 4 is a view illustrating an order of processing of the obstacle detection device according to the first exemplary embodiment of the present disclosure.

FIG. 5 is a flowchart illustrating an operation of the obstacle detection device according to the first exemplary embodiment of the present disclosure.

FIG. 6 is a view illustrating a sound pressure in a resonance frequency band of an ultrasonic wave transmitted from the obstacle detection device according to the first exemplary embodiment of the present disclosure.

FIG. 7 is a block diagram illustrating a configuration of an obstacle detection device according to a second exemplary embodiment of the present disclosure.

FIG. 8 is a flowchart illustrating an operation of the obstacle detection device according to the second exemplary embodiment of the present disclosure.

FIG. 9 is a block diagram illustrating a configuration of an obstacle detection device according to a third exemplary embodiment of the present disclosure.

FIG. 10 is a flowchart illustrating an operation of the obstacle detection device according to the third exemplary embodiment of the present disclosure.

FIG. 11 is a block diagram illustrating a configuration of an obstacle detection device according to a fourth exemplary embodiment of the present disclosure.

FIG. 12 is a view illustrating an ultrasonic wave transmitted from the obstacle detection device according to the fourth exemplary embodiment of the present disclosure.

FIG. 13 is a view illustrating an order of processing of the obstacle detection device according to the fourth exemplary embodiment of the present disclosure.

FIG. 14 is a flowchart illustrating an operation of the obstacle detection device according to the fourth exemplary embodiment of the present disclosure.

### DESCRIPTION OF EMBODIMENTS

A problem of an obstacle detection device will be briefly described prior to description of exemplary embodiments of the present disclosure.

When a plurality of ultrasonic sensors whose detection areas overlap are activated by alternating shifting times, if an obstacle is moving, it is not possible to detect an accurate position of the obstacle. When the obstacle is moving, the position of the obstacle differs between a first timing at which a first ultrasonic sensor measures a distance to the obstacle and a second timing at which a second ultrasonic sensor measures the distance to the obstacle. Hence, even when trilateration is performed based on both of the distances, it is not possible to detect an accurate position of the obstacle.

It is an object of the present disclosure to provide an obstacle detection device which can precisely detect a position of an obstacle by using a plurality of ultrasonic sensors whose detection areas overlap with each other.

The obstacle detection device according to the exemplary embodiments of the present disclosure will be described in detail below appropriately with reference to the drawings.

### First Exemplary Embodiment

<Configuration of Obstacle Detection Device>

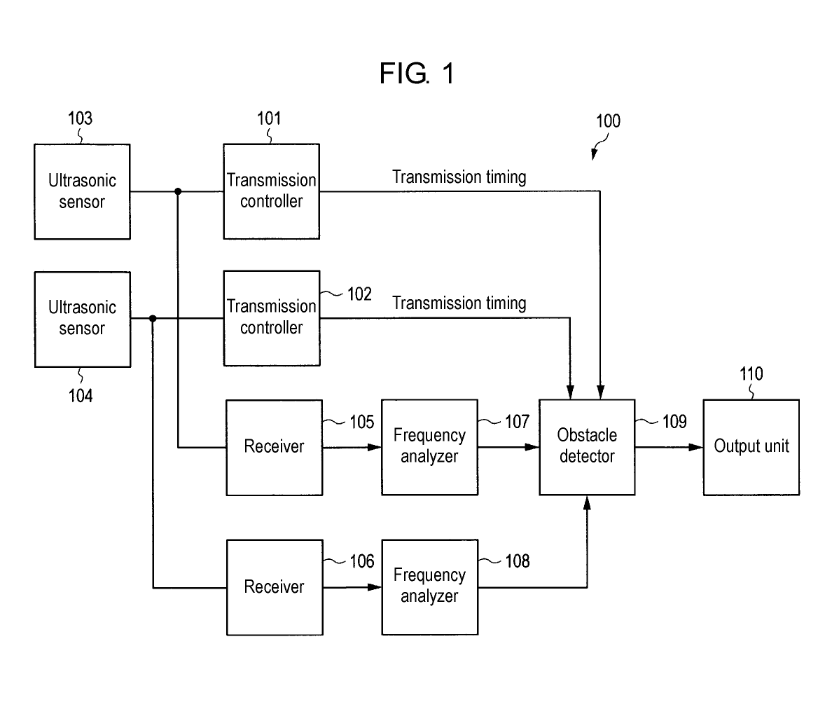

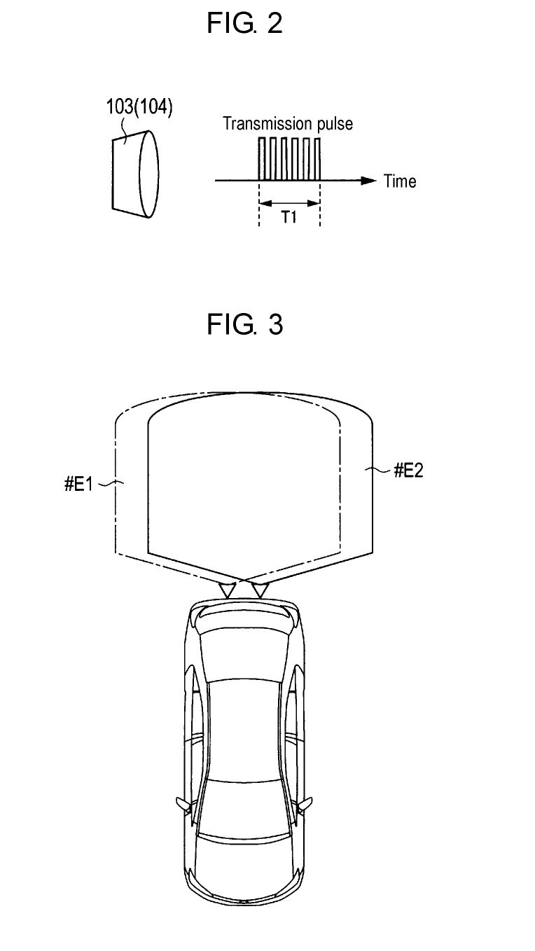

The configuration of obstacle detection device 100 according to the first exemplary embodiment of the present disclosure will be described in detail below with reference to FIGS. 1 and 2.

Obstacle detection device 100 includes two ultrasonic sensors 103, 104, two transmission controllers 101, 102, two receivers 105, 106, two frequency analyzers 107, 108, obstacle detector 109, and output unit 110.

Transmission controller 101 performs control to cause ultrasonic sensor 103 to transmit an ultrasonic wave of predetermined frequency f1 at a predetermined transmission timing. As illustrated in FIG. 2, transmission controller 101 performs control to adjust, to predetermined frequency f1, a frequency of a transmission pulse transmitted in predetermined period T1 from ultrasonic sensor 103. When the ultrasonic wave is a pulse wave illustrated in FIG. 2, the frequency of the ultrasonic wave indicates a frequency of on/off of a pulse. Transmission controller 101 outputs a signal indicating a ultrasonic wave transmission timing to obstacle detector 109.

Transmission controller 102 performs control to cause ultrasonic sensor 104 to transmit an ultrasonic wave of frequency f2 different from the frequency of the ultrasonic wave of ultrasonic sensor 103 at a predetermined timing at least part of which overlaps the transmission timing of ultrasonic sensor 103. As illustrated in FIG. 2, transmission controller 102 performs control to adjust, to predetermined frequency f2, a frequency of a transmission pulse transmitted in predetermined period T1 from ultrasonic sensor 104. Transmission controller 102 outputs a signal indicating a ultrasonic wave transmission timing to obstacle detector 109.

Ultrasonic sensor 103 transmits an ultrasonic wave under control of transmission controller 101. More specifically, ultrasonic sensor 103 transmits the ultrasonic wave under control for causing a piezoelectric element to vibrate. When receiving the ultrasonic wave, ultrasonic sensor 103 converts the ultrasonic wave into an electrical signal, and outputs the electrical signal. As illustrated in FIG. 3, ultrasonic sensor 103 transmits the ultrasonic wave to predetermined detection area #E1. Ultrasonic sensor 103 is provided outside a vehicle body, and, more specifically, may be provided at a back side outside the vehicle body, a front side outside the vehicle body or a side outside the vehicle body.

Ultrasonic sensor 104 transmits the ultrasonic wave under control of transmission controller 102. More specifically, ultrasonic sensor 104 transmits the ultrasonic wave under control for causing the piezoelectric element to vibrate. When receiving the ultrasonic wave, ultrasonic sensor 104 converts the ultrasonic wave into an electrical signal, and outputs the electrical signal. As illustrated in FIG. 3, ultrasonic sensor 104 transmits the ultrasonic wave to detection area #E2 which overlaps a part of detection area #E1 of ultrasonic sensor 103. Ultrasonic sensor 104 is provided at a position located outside the vehicle body and different from a position at which ultrasonic sensor 103 is provided. More specifically, ultrasonic sensor 104 is provided at a position different from the position at which ultrasonic sensor 103 is provided at the back side outside of the vehicle body. The detection areas need to entirely or at least partially overlap with each other.

Receiver 105 outputs to frequency analyzer 107 a signal of a returning ultrasonic wave received by ultrasonic sensor 103 in a period in which ultrasonic sensor 103 does not transmit an ultrasonic wave.

Receiver 106 outputs to frequency analyzer 108 a signal of a returning ultrasonic wave received by ultrasonic sensor 104 in a period in which ultrasonic sensor 104 does not transmit an ultrasonic wave.

Frequency analyzer 107 analyzes frequency components of the signal input from receiver 105. Further, frequency analyzer 107 outputs an analysis result to obstacle detector 109.

Frequency analyzer 108 analyzes frequency components of the signal input from receiver 106. Further, frequency analyzer 108 outputs an analysis result to obstacle detector 109.

In this regard, two frequency analyzers 107, 108 may be configured by one frequency analyzer. In this case, the frequency analyzer needs to be configured to receive an input of a signal obtained by synthesizing received signals of receivers 105, 106, and analyze frequency components of the synthesized signal.

Obstacle detector 109 identifies based on the analysis results input from frequency analyzers 107, 108 whether the received signal includes a reflected wave of the ultrasonic wave transmitted from ultrasonic sensor 103 or includes a reflected wave of the ultrasonic wave transmitted from ultrasonic sensor 104. When the received signal includes the reflected wave, obstacle detector 109 calculates each time difference between a transmission timing of the ultrasonic wave specified by the signals input from transmission controllers 101, 102 and a reception timing of the returning ultrasonic wave. Subsequently, obstacle detector 109 detects an obstacle and a position of the obstacle based on each calculated time difference and a principal of triangulation. Obstacle detector 109 outputs a detection result to output unit 110 when detecting the obstacle and the position of the obstacle.

When receiving an input of the detection result of the obstacle from obstacle detector 109, output unit 110 makes a notification of the input of the detection result. Output unit 110 may make a notification of the input of the detection result by using means such as sound, light or audio which people in a vehicle interior of the vehicle can recognize.

<Operation of Obstacle Detection Device>

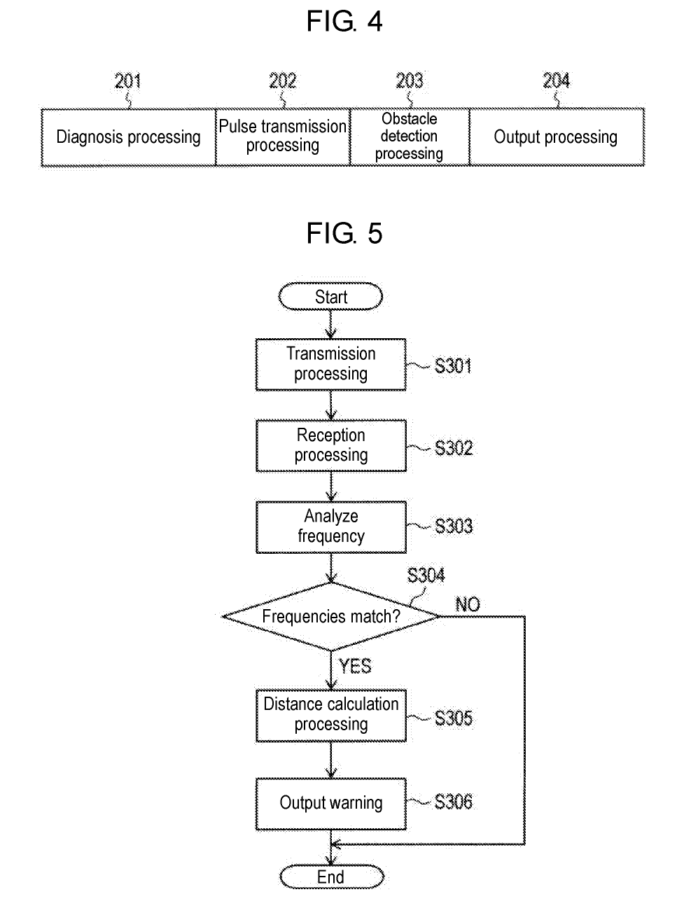

The operation of obstacle detection device 100 according to the first exemplary embodiment of the present disclosure will be described in detail below with reference to FIGS. 4 and 5.

First, as illustrated in FIG. 4, obstacle detection device 100 performs diagnosis processing 201 of diagnosing failures of ultrasonic sensors 103, 104. Diagnosis processing 201 may be omitted.

Subsequently, as illustrated in FIG. 4, obstacle detection device 100 performs pulse transmission processing 202. As illustrated in FIG. 5, during pulse transmission processing 202, transmission controllers 101, 102 perform transmission processing of causing ultrasonic sensors 103, 104 to transmit ultrasonic waves of different frequencies f1 and f2 at the transmission timings at least parts of which overlap with each other (S301).

Next, as illustrated in FIG. 4, obstacle detection device 100 performs obstacle detection processing 203 of detecting an obstacle. As illustrated in FIG. 5, during obstacle detection processing 203, receivers 105, 106 perform reception processing of receiving returning ultrasonic waves received by ultrasonic sensors 103, 104 (S302).

Next, frequency analyzers 107, 108 analyze frequency components (S303).

Next, obstacle detector 109 compares frequencies f1 and f2 of ultrasonic waves transmitted from ultrasonic sensors 103, 104 and the analysis results of frequency analyzers 107, 108, and determines whether or not the frequency of the received ultrasonic wave and the frequency of the transmitted ultrasonic wave match (S304).

In this regard, even when frequencies f1 and f2 of the transmitted ultrasonic waves, and the frequency of the received ultrasonic wave do not completely match, obstacle detector 109 determines that match is found in case where an error between frequencies f1 and f2 and the frequency of the received ultrasonic wave is within an allowable error matching a relative speed of the vehicle and the obstacle. The allowable error takes a value corresponding to a Doppler shift amount of an assumed maximum relative speed of the vehicle and the obstacle.

When obstacle detector 109 determines that the frequency of the transmitted ultrasonic wave and the frequency of the received returning ultrasonic wave do not match (S304: NO), obstacle detection device 100 finishes the processing.

Meanwhile, when the frequency of the transmitted ultrasonic wave and the frequency of the received returning ultrasonic wave match (S304: YES), obstacle detector 109 calculates a distance between each of ultrasonic sensors 103, 104 and the obstacle based on the ultrasonic wave transmission timing and the returning ultrasonic wave reception timing, and further detects a position of the obstacle by performing triangulation (S305).

Next, as illustrated in FIG. 4, obstacle detection device 100 performs output processing 204 of issuing a warning that the obstacle has been detected. According to output processing 204, output unit 110 issues the warming (S306).

Obstacle detection device 100 repeats diagnosis processing 201 to output processing 204.

(Setting of Frequencies f1 and f2 of Ultrasonic Wave)

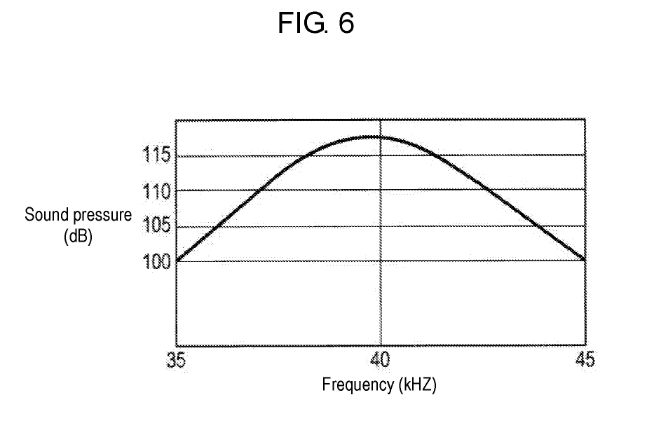

A setting of frequencies f1 and f2 of the ultrasonic waves according to the first exemplary embodiment of the present disclosure will be described in detail below with reference to FIG. 6.

Obstacle detection device 100 which uses ultrasonic waves supports a vehicle velocity of 15 km/h which enables normal obstacle detection processing.

When the relative speed of ultrasonic sensors 103, 104 and the obstacle is 15 km/h and the frequency of the ultrasonic wave is 72 kHz, a maximum Doppler shift frequency is 1.77 kHz and the frequency of the ultrasonic wave is 2.4%.

In the present exemplary embodiment, a first condition is that a difference between frequencies f1 and f2 of the ultrasonic waves of ultrasonic sensors 103, 104 is 2.5% or more of one frequency f1. According to this setting, when a returning ultrasonic wave causes a Doppler shift, reflected waves of two frequencies f1 and f2 do not interfere with each other and are identifiable.

In this regard, taking into account a case where the obstacle is also moving at the substantially same speed as the speed of the vehicle, the relative speed of ultrasonic sensors 103, 104 and the obstacle is 30 km/h, the maximum Doppler shift frequency is 3.44 kHz, and the frequency of the ultrasonic wave is 4.8%. Hence, the difference between frequencies f1 and f2 of the ultrasonic waves of ultrasonic sensors 103, 104 may be set to 5.0% or more of frequency f1, and, in this case, it is possible to support the maximum Doppler shift in case where the obstacle is also moving.

Identical components are used for ultrasonic sensors 103, 104. Consequently, it is possible to reduce component types and reduce cost. The components are identical, so that resonance frequency bands of ultrasonic sensors 103, 104 are identical. A center frequency of the resonance frequency bands is, for example, 40 kHz. The identical components mean the same type, and do not necessarily mean one component.

In this regard, even when the resonance frequency band of ultrasonic sensor 103 and the resonance frequency band of ultrasonic sensor 104 do not completely match, as along as at least parts of the resonance frequency bands are equal and overlap, the components are substantially identical component types and it is possible to reduce cost.

As illustrated in FIG. 6, output levels of ultrasonic sensors 103, 104 become lower when an output level (sound pressure) of the center frequency of the resonance frequency bands is maximum and a difference from the center frequency is greater. It is necessary to increase ultrasonic wave output levels of ultrasonic sensors 103, 104 to detect the obstacle around the vehicle, and the output level attenuated by 20 dB is a lower limit which can maintain normal detection.

In the present exemplary embodiment, a second condition is that a difference between frequencies f1 and f2 of the ultrasonic waves of ultrasonic sensors 103, 104 is set to 25% or less of the center frequency of the resonance frequency bands. Further, both of frequencies f1 and f2 are set to a range of 25% of the center frequency around the center frequency of the resonance frequency bands.

When, for example, one frequency f1 is 35 kHz shifted by −12.5% from 40 kH of the center frequency and other frequency f2 is 45 kHz shifted by +12.5% from 40 kHz of the center frequency, it is possible to maximize the difference between both of frequencies f1 and f2 and reduce attenuation of the ultrasonic wave output levels of both of frequencies f1 and f2 to 20 dB or less.

According to the above setting, in the present exemplary embodiment, ultrasonic sensors 103, 104 transmit ultrasonic waves of different frequencies to detection areas which overlap with each other at different transmission timings. Consequently, it is possible to identify which ultrasonic wave of a reflected wave a returning ultrasonic wave is, and precisely detect an obstacle and a position of the obstacle.

In this regard, in the present exemplary embodiment, a frequency varying unit which varies transmission frequencies of ultrasonic sensors 103, 104 may be added. In this case, the frequency varying unit needs to change the setting such that two frequencies f1 and f2 satisfy the first condition and the second condition.

### Second Exemplary Embodiment

<Configuration of Obstacle Detection Device>

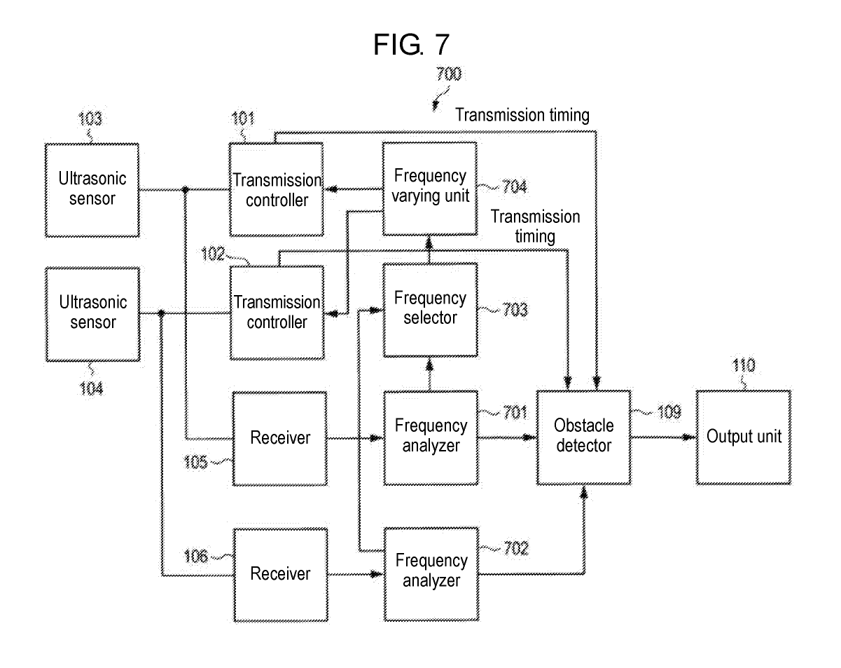

A configuration of obstacle detection device 700 according to the second exemplary embodiment of the present disclosure will be described in detail below with reference to FIG. 7. In this regard, same components in FIG. 7 as components in FIG. 1 will be assigned same reference numerals and will not be described.

Returning ultrasonic waves received by ultrasonic sensors 103, 104 are reflected waves of ultrasonic waves transmitted by ultrasonic sensors 103, 104 and, in addition, surrounding noise ultrasonic waves. The noise ultrasonic waves include ultrasonic waves transmitted from ultrasonic sensors of other vehicles existing in the surroundings. In the second exemplary embodiment, a function of reducing interference between the ultrasonic waves transmitted by ultrasonic sensors 103, 104 and the noise ultrasonic waves existing in the surroundings is added.

Obstacle detection device 700 includes transmission controller 101, transmission controller 102, ultrasonic sensor 103, ultrasonic sensor 104, receiver 105, receiver 106, obstacle detector 109, output unit 110, frequency analyzer 701, frequency analyzer 702, frequency selector 703 and frequency varying unit 704.

Transmission controller 101 performs control to cause ultrasonic sensor 103 to transmit an ultrasonic wave of frequency f1 changed by frequency varying unit 704.

Transmission controller 102 performs control to cause ultrasonic sensor 104 to transmit an ultrasonic wave of frequency f2 changed by frequency varying unit 704 at a predetermined transmission timing at least a part of which overlaps with the ultrasonic wave transmitted from ultrasonic sensor 103.

Receiver 105 outputs to frequency analyzer 701 a signal of a returning ultrasonic wave received by ultrasonic sensor 103 in a period in which ultrasonic sensor 103 does not transmit an ultrasonic wave.

Receiver 106 outputs to frequency analyzer 702 a signal of a returning ultrasonic wave received by ultrasonic sensor 104 in a period in which ultrasonic sensor 104 does not transmit an ultrasonic wave.

Frequency analyzer 701 analyzes frequency components of the signal input from receiver 105, and outputs an analysis result to frequency selector 703 and obstacle detector 109.

Frequency analyzer 702 analyzes frequency components of the signal input from receiver 106, and outputs an analysis result to frequency selector 703 and obstacle detector 109.

Frequency selector 703 selects frequencies f1 and f2 of ultrasonic sensor 103 and ultrasonic sensor 104, and outputs a selection result to frequency varying unit 704. Frequencies f1 and f2 are selected to satisfy a first condition and a second condition described in the first exemplary embodiment.

Frequency varying unit 704 sets frequency f1 to transmission controller 101 and sets frequency f2 to transmission controller 102 according to the selection result input from frequency selector 703.

Obstacle detector 109 calculates each time difference between an ultrasonic wave transmission timing and a returning ultrasonic wave reception timing based on the analysis results of frequency analyzers 701, 702, and detects a position of an obstacle based on each calculated time difference and a principal of triangulation. Obstacle detector 109 outputs an obstacle detection result to output unit 110.

<Operation of Obstacle Detection Device>

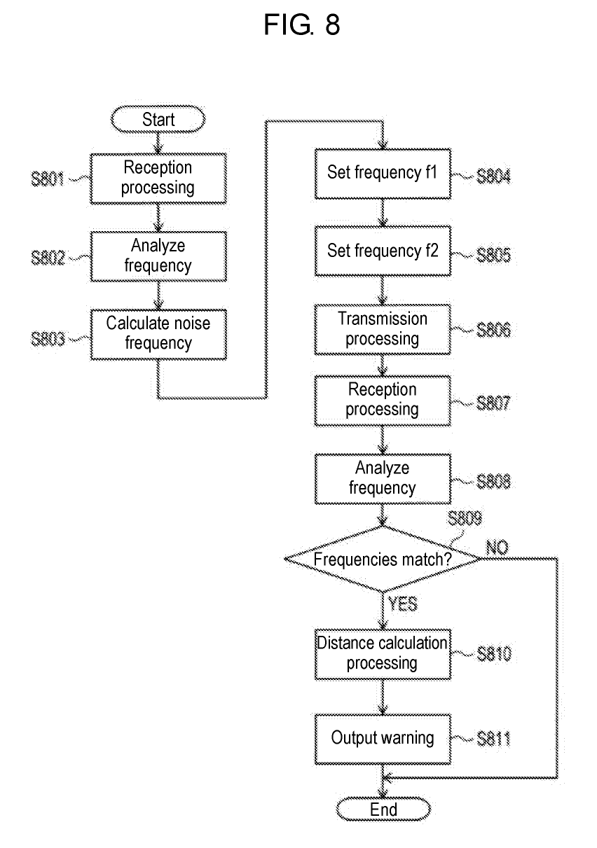

An operation of obstacle detection device 700 according to the second exemplary embodiment of the present disclosure will be described in detail below with reference to FIG. 8. In this regard, obstacle detection device 700 performs each processing in an order identical to an order in FIG. 4.

First, as illustrated in FIG. 4, obstacle detection device 700 performs diagnosis processing 201 of diagnosing failures of ultrasonic sensors 103, 104. According to diagnosis processing 201, receivers 105, 106 receive signals of the ultrasonic waves received by ultrasonic sensors 103, 104 (S801). The received ultrasonic waves are received ultrasonic waves without transmitting ultrasonic waves, and therefore are noise ultrasonic waves existing in surroundings. Noise reception control processing is performed in this way.

Next, frequency analyzers 701, 702 analyze the frequency components (S802), and perform an arithmetic operation to calculate frequency components of noise ultrasonic waves used in the surroundings of a vehicle (S803).

Next, frequency selector 703 selects frequencies f1 and f2 of ultrasonic sensors 103, 104 such that frequencies f1 and f2 do not interfere with frequencies of the noise ultrasonic waves obtained based on the analysis results of frequency analyzers 701, 702. Frequency selector 703 selects frequencies f1 and f2 to satisfy the first condition and the second condition described in the first exemplary embodiment. Frequency varying unit 704 sets frequency f1 to transmission controller 101 (S804). Further, frequency varying unit 704 sets frequency f2 to transmission controller 102 (S805). Thus, by selecting the frequencies during diagnosis processing 201, it is possible to perform the diagnosis processing and frequency selection in parallel, and, consequently, it is possible to shorten an obstacle detection processing cycle period.

Next, obstacle detection device 700 performs pulse transmission processing 202. During pulse transmission processing 202, transmission controllers 101, 102 perform transmission processing of causing ultrasonic sensors 103, 104 to transmit ultrasonic waves of frequencies f1 and f2 set at the transmission timings which overlap with each other (S806).

Next, obstacle detection device 700 performs obstacle detection processing 203 which is identical to processing illustrated in FIG. 5 and detects an obstacle. During obstacle detection processing 203, receivers 105, 106 perform reception processing of receiving returning ultrasonic waves received by ultrasonic sensors 103, 104 at overlapping reception timings (S807).

Next, frequency analyzers 701, 702 analyze frequency components (S808).

Next, obstacle detector 109 determines whether or not frequencies f1 and f2 of the ultrasonic waves transmitted from ultrasonic sensors 103, 104, and the frequencies of the returning ultrasonic waves obtained based on the analysis results of frequency analyzers 701, 702 match (S809). Determination is performed based on comparison performed by taking into account an allowable error similar to the first exemplary embodiment.

When obstacle detector 109 determines that the frequency of the transmitted ultrasonic wave and the frequency of the received returning ultrasonic wave do not match (S809: NO), obstacle detection device 700 finishes processing.

Meanwhile, when the frequency of the transmitted ultrasonic wave and the frequency of the received returning ultrasonic wave match (S809: YES), obstacle detector 109 detects a position of the obstacle based on a time difference between each ultrasonic wave transmission timing and each returning ultrasonic wave reception timing of ultrasonic sensors 103, 104 and the principal of triangulation (S810).

Next, as illustrated in FIG. 4, obstacle detection device 700 performs output processing 204 of issuing from output unit 110 that the obstacle has been detected (S811).

Obstacle detection device 700 repeats diagnosis processing 201 to output processing 204.

Thus, according to the present exemplary embodiment, in addition to an effect of the first exemplary embodiment, an ultrasonic wave of a frequency other than noise frequencies used in the surroundings of the vehicle is transmitted. Consequently, it is possible to prevent not only a mutual interference between ultrasonic sensor 103 and ultrasonic sensor 104 but also interference with ultrasonic waves transmitted from objects outside the vehicle, and precisely detect obstacles and positions of obstacles.

### Third Exemplary Embodiment

<Configuration of Obstacle Detection Device>

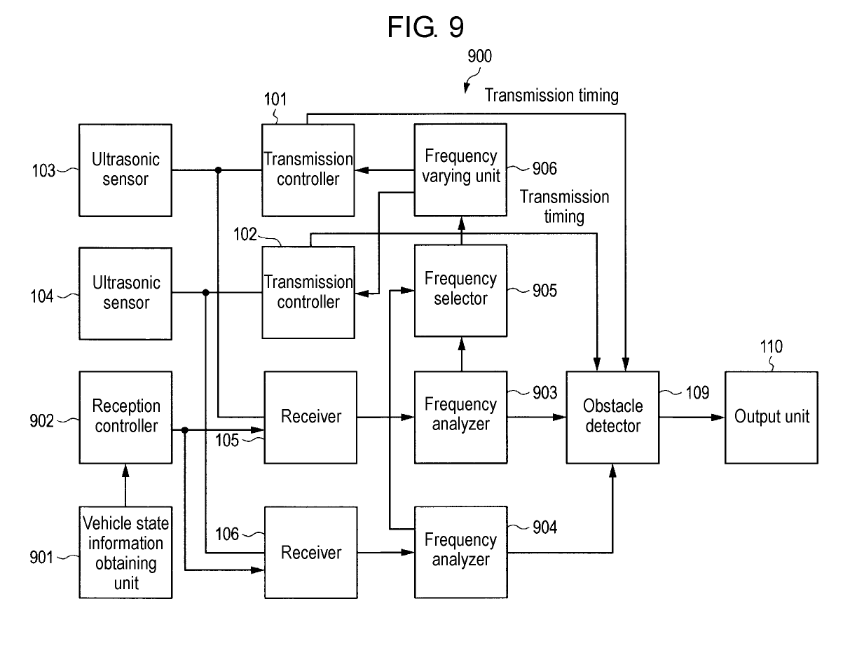

A configuration of obstacle detection device 900 according to the third exemplary embodiment of the present disclosure will be described in detail below with reference to FIG. 9. In this regard, same components in FIG. 9 as components in FIG. 1 will be assigned same reference numerals and will not be described.

The third exemplary embodiment differs from the second exemplary embodiment in a timing to detect noise ultrasonic waves existing in surroundings.

Obstacle detection device 900 includes transmission controller 101, transmission controller 102, ultrasonic sensor 103, ultrasonic sensor 104, receiver 105, receiver 106, obstacle detector 109, output unit 110, vehicle state information obtaining unit 901, reception controller 902, frequency analyzer 903, frequency analyzer 904, frequency selector 905 and frequency varying unit 906.

Transmission controller 101 performs control to cause ultrasonic sensor 103 to transmit an ultrasonic wave of frequency f1 changed by frequency varying unit 906.

Transmission controller 102 performs control to cause ultrasonic sensor 104 to transmit an ultrasonic wave of frequency f2 changed by frequency varying unit 906 at a predetermined transmission timing at least a part of which overlaps with the ultrasonic wave transmitted from ultrasonic sensor 103.

Vehicle state information obtaining unit 901 obtains vehicle state information related to a driving state of a vehicle, and outputs the vehicle state information to reception controller 902. In this regard, the vehicle state information typically includes shift information indicating a shift position of a shift lever of the vehicle, brake information indicating a brake operation and vehicle speed information indicating a vehicle speed of the vehicle.

Reception controller 902 performs control to cause receivers 105, 106 to perform reception processing according to the vehicle state information input from vehicle state information obtaining unit 901.

Receiver 105 has a function of starting the reception processing under control of reception controller 902 in addition to a function described in the second exemplary embodiment. Further, receiver 105 outputs to frequency analyzer 903 a signal of an ultrasonic wave received by ultrasonic sensor 103 in a period in which ultrasonic sensor 103 does not transmit an ultrasonic wave.

Receiver 106 has a function of starting the reception processing under control of reception controller 902 in addition to the function described in the second exemplary embodiment. Further, receiver 105 outputs to frequency analyzer 904 a signal of an ultrasonic wave received by ultrasonic sensor 104 in a period in which ultrasonic sensor 104 does not transmit an ultrasonic wave.

Frequency analyzer 903 analyzes frequency components of the signal input from receiver 105, and outputs an analysis result to frequency selector 905 and obstacle detector 109.

Frequency analyzer 904 analyzes frequency components of the signal input from receiver 106, and outputs an analysis result to frequency selector 905 and obstacle detector 109.

Frequency selector 905 selects frequencies f1 and f2 of ultrasonic sensors 103, 104 based on the analysis results input from frequency analyzers 903, 904, and outputs a selection result to frequency varying unit 906. Frequencies f1 and f2 are selected in a range satisfying a first condition and a second condition described in the first exemplary embodiment.

Frequency varying unit 906 sets frequency f1 to transmission controller 101 and frequency f2 to transmission controller 102 based on the selection result input from frequency selector 905.

Obstacle detector 109 calculates each time difference between an ultrasonic wave transmission timing and a returning ultrasonic wave reception timing based on the analysis results of frequency analyzers 903, 904, and detects a position of an obstacle based on each calculated time difference and a principal of triangulation. Obstacle detector 109 outputs an obstacle detection result to output unit 110.

<Operation of Obstacle Detection Device>

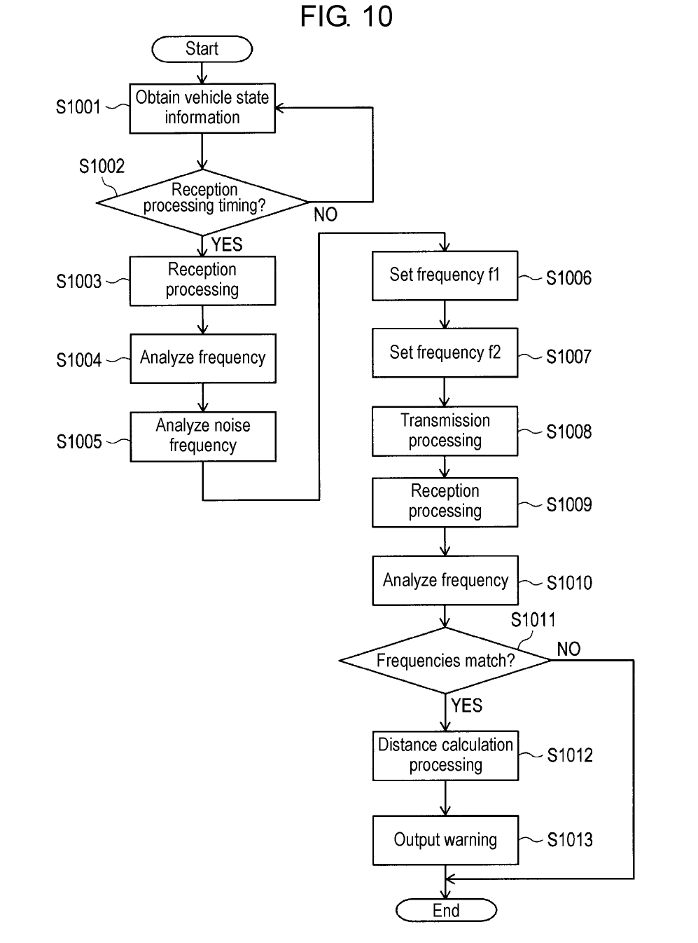

An operation of obstacle detection device 900 according to the third exemplary embodiment of the present disclosure will be described in detail below with reference to FIG. 10.

First, vehicle state information obtaining unit 901 obtains the vehicle state information (S1001).

Next, reception controller 902 determines whether or not a reception processing timing comes, based on the vehicle state information (S1002).

When the reception processing timing does not come yet (S1002: NO), reception controller 902 stands by until the reception processing timing comes.

Meanwhile, when the reception processing timing comes (S1002: YES), reception controller 902 performs control to cause receivers 105, 106 to start the reception processing (S1003). More specifically, reception controller 902 determines that the reception processing timing comes when obtaining shift information indicating that a shift lever changes from a drive (D) position to a reverse (R) position, when obtaining shift information indicating that the shift lever changes from a parking (P) position to a reverse (R) position, when obtaining information of a vehicle speed sensor indicating that the vehicle changes from stop to acceleration, when obtaining information of the vehicle speed sensor indicating that the vehicle decelerates and accelerates in an opposite direction, and when obtaining brake information indicating that an activated shift brake is deactivated.

Next, receivers 105, 106 receive signals of ultrasonic waves received by ultrasonic sensors 103, 104 (S1003).

Next, frequency analyzers 903, 904 analyze the frequency components (S1004), and perform an arithmetic operation to calculate frequency components of noise frequencies used in the surroundings of the vehicle (S1005).

Steps S1005 to S1013 are identical to steps S803 to S811 in FIG. 8, and therefore will not be described.

Obstacle detection device 900 according to the third exemplary embodiment can automatically execute processing of detecting noise ultrasonic waves in the surroundings and processing of detecting obstacles at appropriate timings.

### Fourth Exemplary Embodiment

<Configuration of Obstacle Detection Device>

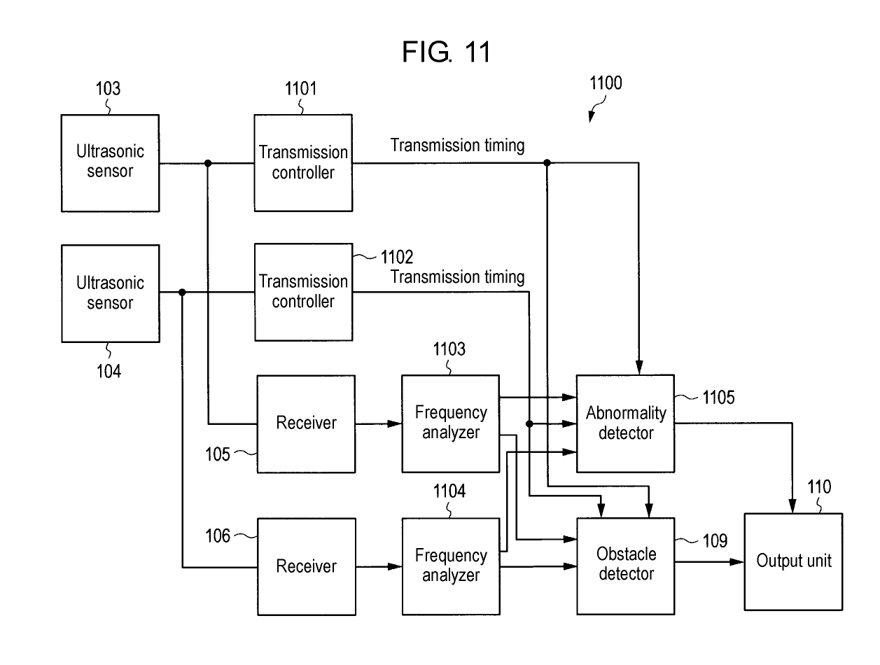

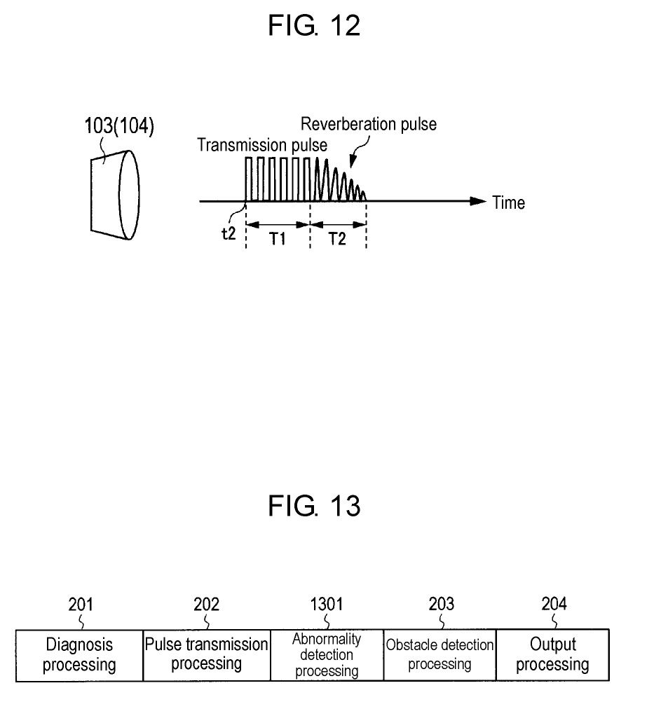

The configuration of obstacle detection device 1100 according to the fourth exemplary embodiment of the present disclosure will be described in detail below with reference to FIGS. 11 and 12. In this regard, same components in FIG. 11 as components in FIG. 1 will be assigned same reference numerals and will not be described.

Obstacle detection device 1100 includes ultrasonic sensor 103, ultrasonic sensor 104, receiver 105, receiver 106, obstacle detector 109, output unit 110, transmission controller 1101, transmission controller 1102, frequency analyzer 1103, frequency analyzer 1104 and abnormality detector 1105.

As illustrated in FIG. 12, transmission controller 1101 performs control to cause ultrasonic sensor 103 to transmit an ultrasonic wave of predetermined frequency f1 in predetermined period T1 from predetermined time t2. Transmission controller 1101 outputs a signal indicating a ultrasonic wave transmission timing to obstacle detector 109 and abnormality detector 1105.

Transmission controller 1102 performs control to cause ultrasonic sensor 104 to transmit an ultrasonic wave of frequency f2 in predetermined period T1 from time t2 at a transmission timing which overlaps with the ultrasonic wave transmitted from ultrasonic sensor 103. Transmission controller 1102 outputs a signal indicating a ultrasonic wave transmission timing to obstacle detector 109 and abnormality detector 1105.

Ultrasonic sensor 103 transmits the ultrasonic wave of predetermined frequency f1 at a predetermined timing by vibrating a piezoelectric element under control of transmission controller 1101. When receiving the ultrasonic wave, the piezoelectric element vibrates, and ultrasonic sensor 103 converts the ultrasonic wave into an electrical signal.

Ultrasonic sensor 104 transmits the ultrasonic wave of predetermined frequency f2 at a predetermined timing by vibrating a piezoelectric element under control of transmission controller 1102. When receiving the ultrasonic wave, the piezoelectric element vibrates, and ultrasonic sensor 104 converts the ultrasonic wave into an electrical signal.

Frequency analyzer 1103 analyzes frequency components of the signal input from receiver 105, and outputs an analysis result to abnormality detector 1105 and obstacle detector 109.

Frequency analyzer 1104 analyzes frequency components of the signal input from receiver 106, and outputs an analysis result to abnormality detector 1105 and obstacle detector 109.

Abnormality detector 1105 determines whether or not a system abnormality occurs, based on the analysis results input from frequency analyzers 1103, 1104, and outputs the system abnormality determination result to output unit 110.

As illustrated in FIG. 12, abnormality detector 1105 inspects a received signal to learn whether or not the ultrasonic wave transmitted by other ultrasonic sensor 104 is received by one ultrasonic sensor 103 in period T1 in which one ultrasonic sensor 103 transmits the ultrasonic wave and in period T2 in which a reverberation signal is produced. Similarly, abnormality detector 1105 inspects a received signal to learn whether or not the ultrasonic wave transmitted by one ultrasonic sensor 103 is received by other ultrasonic sensor 104 in period T1 in which other ultrasonic sensor 104 transmits the ultrasonic wave and in period T2 in which a reverberation signal is produced.

Normally, the periods T1 and T2 are dead periods in which ultrasonic waves which are being transmitted and received ultrasonic waves are not distinguishable, and therefore reception processing is not performed. However, in the present exemplary embodiment, frequencies f1 and f2 of the ultrasonic waves of two ultrasonic sensors 103, 104 are different. Consequently, it is possible to distinguish between the ultrasonic wave transmitted by one ultrasonic sensor 103 and the ultrasonic wave transmitted by other ultrasonic sensor 104 and received by one ultrasonic sensor 103 in the dead periods, too. Consequently, when the system is normal, the received signal in periods T1 and T2 of one ultrasonic sensor 103 includes a signal of the ultrasonic wave of other ultrasonic sensor 104. Further, when the system is normal, the received signal in periods T1 and T2 of other ultrasonic sensor 104 includes a signal of the ultrasonic wave of one ultrasonic sensor 103. Consequently, abnormality detector 1105 determines that the system is normal when the signal can be detected, and determines that the system is abnormal when the signal cannot be detected.

When receiving an input of a detection result of the obstacle from obstacle detector 109, output unit 110 issues a warning. Output unit 110 outputs a determination result input from abnormality detector 1105. Output unit 110 outputs the determination result by using means such as sound, light or audio which people in a vehicle interior of the vehicle can recognize.

<Operation of Obstacle Detection Device>

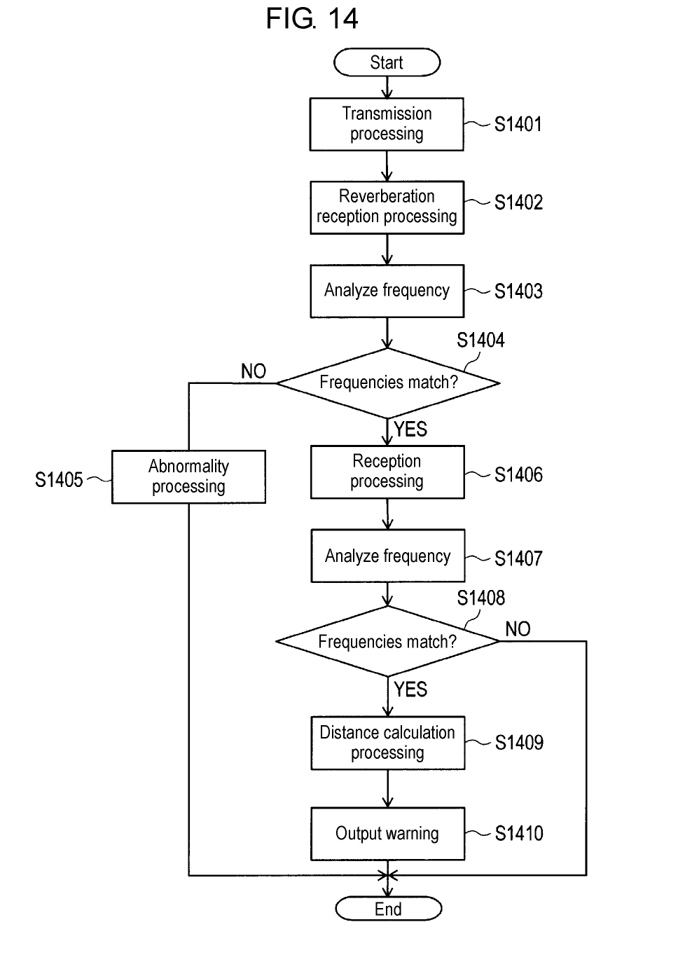

The operation of obstacle detection device 1100 according to the fourth exemplary embodiment of the present disclosure will be described in detail below with reference to FIGS. 13 and 14. In this regard, same processing in FIG. 13 as processing in FIG. 4 will be assigned same reference numerals.

First, as illustrated in FIG. 13, obstacle detection device 1100 performs diagnosis processing 201 of diagnosing failures of ultrasonic sensors 103, 104, and then performs pulse transmission processing 202.

During pulse transmission processing 202, transmission controllers 1101, 1102 perform transmission processing of causing ultrasonic sensors 103, 104 to transmit ultrasonic waves of different frequencies at the transmission timings at least parts of which overlap with each other (S1401).

Next, as illustrated in FIG. 13, obstacle detection device 1100 performs obstacle detection processing 1301 of detecting a system abnormality.

During abnormality detection processing 1301, receivers 105, 106 perform reception processing of ultrasonic sensors 103, 104 in period T2 in particular in which a reverberation signal remains among dead periods T1 and T2 immediately after a transmission timing (S1402).

Next, frequency analyzers 1103, 1104 analyze frequency components (S1403).

Next, abnormality detector 1105 determines whether or not the frequency of the ultrasonic wave obtained and received based on an analysis result of frequency analyzer 1103 and the frequency of the ultrasonic wave transmitted from ultrasonic sensor 104 match. Further, abnormality detector 1105 determines whether or not the frequency of the ultrasonic wave obtained and received based on an analysis result of frequency analyzer 1104 and the frequency of the ultrasonic wave transmitted from ultrasonic sensor 103 match (S1404). That is, abnormality detector 1105 determines whether or not the frequency of the signal received by one ultrasonic sensor 103 and the frequency of the ultrasonic wave transmitted by other ultrasonic sensor 104 match. Further, abnormality detector 1105 determines whether or not the frequency of the signal received by other ultrasonic sensor 104 and the frequency of the ultrasonic wave transmitted by one ultrasonic sensor 103 match.

When at least one of comparison results indicates a mismatch (S1404: NO), abnormality detector 1105 performs abnormality processing of outputting to output unit 110 a determination result for causing output unit 110 to output a system abnormality (S1405), and finishes processing.

Meanwhile, when both of the comparison results indicate the match (S1404: YES), obstacle detection device 1100 performs obstacle detection processing 203 of detecting the obstacle as illustrated in FIG. 13.

Processing in subsequent steps S1406 to S1410 is the same as processing in steps S302 to S306 in the first exemplary embodiment, and therefore will not be described.

Obstacle detection device 1100 repeats diagnosis processing 201 to output processing 204 in FIG. 13.

Obstacle detection device 1100 according to the fourth exemplary embodiment can perform self-diagnosis processing performed by cooperating a plurality of ultrasonic sensors 103, 104, and can detect an abnormality which cannot be found by diagnosis processing executed only by individual ultrasonic sensors 103, 104. Further, dead periods in which reverberation signals are produced are used, and therefore a cycle period for detecting an obstacle is not long when the self-diagnosis processing is taken into account.

In this regard, the function of the self-diagnosis processing according to the present exemplary embodiment is applicable to the second exemplary embodiment or the third exemplary embodiment having a frequency selecting or frequency varying function.

The exemplary embodiments of the present disclosure have been described above.

In this regard, types, arrangements and numbers of members are not limited to the above-described exemplary embodiments, and the present disclosure can be optionally changed without departing from the scope of the disclosure by optionally replacing components with components which provide equivalent functions and effects.

For example, a configuration where a frequency of a received signal is analyzed and a reflected wave is identified has been described in the first exemplary embodiment to the fourth exemplary embodiment. However, a filter which allows a frequency band of ultrasonic waves transmitted from ultrasonic sensors 103, 104 to pass may be used to identify a reflected wave by using signals which pass through the filter.

Further, a warning has been issued when an obstacle is detected in the first exemplary embodiment to the fourth exemplary embodiment. However, the vehicle may be controlled to prevent collision between the vehicle and obstacles.

Further, two ultrasonic sensors have been provided in the first exemplary embodiment to the fourth exemplary embodiment. However, three or more ultrasonic sensors may be provided.

An obstacle detection device according to the present disclosure can be used for a device which detects obstacles existing around a vehicle.

1. An obstacle detection device which is mounted on a vehicle, the obstacle detection device comprising:
a plurality of ultrasonic sensors which transmits a plurality of ultrasonic waves of different frequencies to detection areas at least parts of which overlap with each other at transmission timings at least parts of which overlap with each other, and each of the ultrasonic sensors receives a returning ultrasonic wave; and
a detector which identifies which one ultrasonic sensor of the plurality of ultrasonic sensors has transmitted the returning ultrasonic wave, and detects a position of an obstacle existing around the vehicle.

2. The obstacle detection device according to claim 1, wherein
the plurality of ultrasonic sensors has resonance frequency bands at least parts of which overlap, and
a difference between the frequencies to transmit the plurality of ultrasonic waves is 2.5% or more of a frequency of one ultrasonic wave of the plurality of ultrasonic waves and 25% or less of the center frequency of the resonance frequency bands of the one ultrasonic sensor.

3. The obstacle detection device according to claim 2, wherein the frequencies of the ultrasonic waves transmitted by the plurality of ultrasonic sensors are set to be included in a range of 25% of the center frequency around the center frequency of the resonance frequency bands of the plurality of ultrasonic sensors.

4. The obstacle detection device according to claim 1, further comprising a frequency analyzer which analyzes a frequency of the returning ultrasonic wave received by the plurality of ultrasonic sensors,
wherein the detector detects the obstacle based on an analysis result of the frequency analyzer.

5. The obstacle detection device according to claim 4, wherein the detector determines whether or not the frequency of the returning ultrasonic wave is included in a range formed by adding an allowable error to a frequency of an ultrasonic wave transmitted from one of the plurality of ultrasonic sensors, and determines which one of the plurality of ultrasonic sensors has transmitted the returning ultrasonic wave as a reflected wave of an ultrasonic wave.

6. The obstacle detection device according to claim 4, further comprising:
a frequency varying unit which changes the frequencies of the ultrasonic waves transmitted from the plurality of ultrasonic sensors; and
a frequency selector which sets a frequency different from a frequency of an ultrasonic wave received by at least one of the plurality of ultrasonic sensors without transmitting an ultrasonic wave, to the plurality of ultrasonic sensors.

7. The obstacle detection device according to claim 6, further comprising:
a reception controller which performs noise reception control processing of causing at least one of the plurality of ultrasonic sensors to receive an ultrasonic wave without transmitting an ultrasonic wave; and
a vehicle state information obtaining unit which obtains vehicle state information,
wherein the reception controller starts the noise reception control processing based on the obtained vehicle state information.

8. The obstacle detection device according to claim 7, wherein the reception controller starts the noise reception control processing based on the vehicle state information when specific shift information changes or specific brake information changes.

9. The obstacle detection device according to claim 7, wherein the reception controller starts the noise reception control processing based on the vehicle state information when movement of the vehicle makes a specific change.

10. The obstacle detection device according to claim 7, wherein the reception controller executes the noise reception control processing during diagnosis processing of the plurality of ultrasonic sensors.
